(19) United States
(12) Patent Application Publication
(10) Pub. No.: US 2006/0268328 A1
(43) Pub. Date: Nov. 30, 2006

(54) Printing system and printing control method

(75) Inventors: Chang-soo Park, Seoul (KR); In-sung Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/413,194

(22) Filed: Apr. 28, 2006

(30) Foreign Application Priority Data
May 31, 2005 (KR) 2005-46458

(51) Int. Cl. G06F 3/12

(52) U.S. Cl. 358/1.15; 358/1.13; 358/1.2

(57) ABSTRACT

A printing control method. The method includes detecting a size of a recording medium in a tray of a printing apparatus, transmitting the detected size of the recording medium to at least one host apparatus, and registering the transmitted size of the recording medium at a printer driver of the host apparatus when the transmitted the size of the recording medium is not pre-registered at the printer driver.

### CROSS-REFERENCE TO RELATED APPLICATIONS

This application claims the benefit of Korean Application No. 2005-46458, filed May 31, 2005, in the Korean Intellectual Property Office, the disclosure of which is incorporated herein by reference.

### BACKGROUND OF THE INVENTION

1. Field of the Invention

Aspects of the present invention relate to a printing system and printing control method. More particularly, the present invention relates to a printing system and printing control method automatically registering nonstandardized sizes of recording media, such as paper, in a tray of a printing apparatus, to a printer driver of a host apparatus.

2. Description of the Related Art

In order to print documents, using a host apparatus such as a computer, a user forms and edits a document, converts the document into printing data having an applied paper size, and transmits the printing data to a printing apparatus, such as a printer or a multi-functional apparatus. The size of the paper for the document is generally designated by the user, from among default printer driver supported paper sizes.

Nonstandardized paper sizes (i.e., paper sizes not supported by the printer driver), are used in many cases at governmental buildings or public institutions. The user, here, directly sets the user-defined size of paper. This caused inconvenience to the user.

In addition, where a user defined size of paper is different from the actual size of paper in a tray of the printing apparatus, a part of the printing data, may not be printed.

### SUMMARY OF THE INVENTION

An aspect of the present invention is to solve the above and/or other problems and disadvantages of the related art and to provide at least the advantages described below. Accordingly, an aspect of the present invention provides a printing system and a printing control method enabling a user to make sizes of nonstandardized recording media (such as paper) loaded in a tray of a printing apparatus fit for default-defined sizes of recording media by automatic registration.

In order to achieve the above-described aspects of the present invention, there is provided a printing control method, comprising: detecting a size of a recording medium in a tray of a printing apparatus; transmitting the detected size of the recording medium to at least one host apparatus; and registering the transmitted size of the recording medium at a printer driver of the host apparatus when the transmitted the size of the recording medium is not pre-registered at the printer driver.

The printing control method may further comprise indicating a list of size of recording medium including the registered size of the recording medium when a command is input for selecting the recording medium. The transmitting to the host apparatus transmits the detected size of the recording medium to at least one host apparatus, when the detected size of the recording medium is nonstandardized. When the printing apparatus is connected with the host apparatus through network, the detected size of the recording medium is broadcast to the host apparatus. The registering at the printer driver is the transmitted size of recording medium into a script file of the printer driver.

In order to achieve the above-described aspects of the present invention, there is provided a printing control method for use with a host apparatus directly connected to a printing apparatus and at least one client sharing the printing apparatus through the host apparatus, the method comprising: detecting a size of the recording medium in a tray of the printing apparatus; transmitting the detected size of the recording medium to a host apparatus; and registering the transmitted size of the recording medium at a printer driver of the host apparatus when the transmitted size of the recording medium is not pre-registered at the printer driver.

Another printing control method may further comprise registering the size of the recording medium registered during the registering at a printer driver of the client. The registering may include the transmitted size of recording medium into a script file of the printer driver of the host apparatus. The registering the size of the recording medium registered during the registering comprises transmitting the script file of the printer driver of the host apparatus including the size of the recording medium to the client and including the size of the recording medium included in the transmitted script file of the printer driver of the host apparatus, into the script file of the client's printer driver.

In order to achieve the above-described aspects of the present invention, there is provided a printing apparatus, comprising: a tray to house a recording medium therein, a detecting part to detect the size of the recording medium in the tray; and a printing apparatus controlling part to transmit the detected size of the recording medium to at least one host apparatus and to register the size with a printer driver installed at the host apparatus.

The printing system further comprises a storing part for storing a predetermined standardized size of the recording medium, and the printing apparatus controlling part compares the detected size of the recording medium with the standardized size of the recording medium. When the detected size of the recording medium is a nonstandardized size, the printing apparatus controlling part transmits the detected size of recording medium to at the host apparatus. The printing apparatus controlling part, when connected with at least one host apparatus through a network, broadcasts the detected size of the recording medium to the host apparatus. The host apparatus includes a printer driver creating printing data interpretable at the printing apparatus according to an embodiment of the present invention, comprises a state detecting part for receiving a size of the recording medium in a tray of the printing apparatus, and a host apparatus controlling part for registering size of the transmitted recording medium to the printer driver when the received size of the recording medium is not pre-registered to the printer driver. The printer driver displays a list of sizes of the recording medium including the registered size of the recording medium when a command for selecting the recording medium is received. The printer driver includes the script file where the received size of the recording medium is registered.

In order to achieve the above-described and/or other aspects of the present invention, there is provided a printing system, including a printing apparatus with a tray housing a recording medium therein and at least one host apparatus with a printer driver creating printing data interpretable by the printing apparatus, the printing system comprising: a recording medium size detecting part to detect a size of the recording medium in the tray; a printing apparatus controlling part to transmit the detected size of the recording medium to the host apparatus; a state detecting part to receive the transmitted size of the recording medium; and a host apparatus controlling part to register the received size of the recording medium to the printer driver when the received size of the recording medium is not pre-registered in the printer driver.

In order to achieve the above-described and/or other aspects of the present invention, there is provided a printing system including a host apparatus directly connected to a printing apparatus having a tray and at least one client sharing the printing apparatus through the host apparatus, the printing system comprising: a recording medium size detecting part to detect a size of a recording medium in the tray; a printing apparatus controlling part to transmit the detected size of the recording medium to the host apparatus; a host apparatus controlling part to register the transmitted size of the recording medium to the printer driver of the host apparatus, when the transmitted size of the recording medium is not pre-registered in the printer driver of the host apparatus; and a client controlling part to register the size of the recording medium registered in the printer driver of the host apparatus to a printer driver of the client.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a printing system according to a first embodiment of the present invention,

FIG. 2 is a detailed block diagram of the printing apparatus of FIG. 1, and FIG. 3 is a detailed block diagram of a first host apparatus of FIG. 1,

FIG. 3 is a detailed block diagram of the first host apparatus of FIG. 1,

FIG. 4 is a flow chart of a printing control method of the printing system according to the first embodiment of the present invention,

FIG. 5 is a block diagram of the printing system according to a second embodiment of the present invention, and

FIG. 6 is a detailed block diagram of a first client of FIG. 5.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

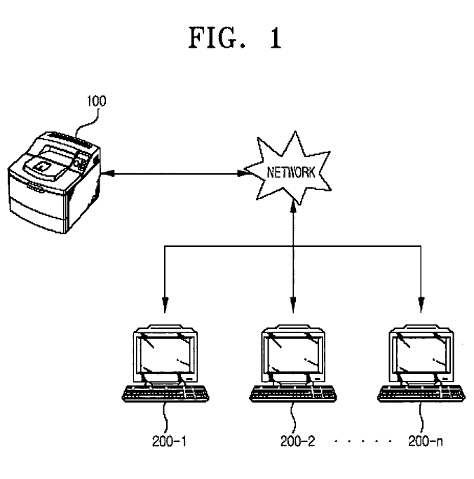

FIG. 1 is a block diagram of a printing system according to a first embodiment of the present invention. Referring to FIG. 1, the printing system comprises a printing apparatus 100 and first through n host apparatuses 200-1, 200-2, . . . , 200-n connected to the printing apparatus 100 through a network. The network may be formed by a sharer such as a LAN (Local Area Network) and a HUB, and the Internet, or a combination thereof. In particular, in companies or public offices, the network may also be formed by an Intranet based on TCP/IP protocols, or a combination thereof.

The printing apparatus 100 prints printing data transmitted from the first through the n host apparatuses 200-1, 200-2, . . . , 200-n. Particularly, the printing apparatus 100 detects information on a size of the recording medium in a tray of the printing apparatus (not shown) and transmits the information to the first through the n host apparatuses 200-1, 200-2, . . . , 200-n. According to an embodiment of the invention, the information may also be broadcast to all the host apparatuses and/or to a particular host apparatus.

The first through the n host apparatuses 200-1, 200-2, . . . , 200-n each form printing data and each transmits the formed printing data to the printing apparatus 100. The host apparatus may be a computer. In particular, each of the first through the n host apparatuses (200-1, 200-2, . . . , 200-n) automatically registers information on a size of a recording medium (i.e. paper or other recording medium such as an overhead or a transparency) that is transmitted from the printing apparatus 100 to a printer driver 100 and, when a command to select a recording medium is received from a user, displays a list of the sizes of various recording media including the size of the recording medium that is transmitted from the printing apparatus 100. Even if the recording medium in the tray of the printing apparatus 100 is not registered to the printer driver, the user does not need to manually register the corresponding size of the recording medium to the printer driver, because the size of the recording medium is recognized as being supported as a default size.

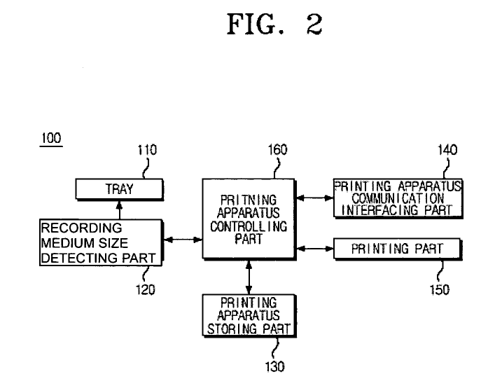

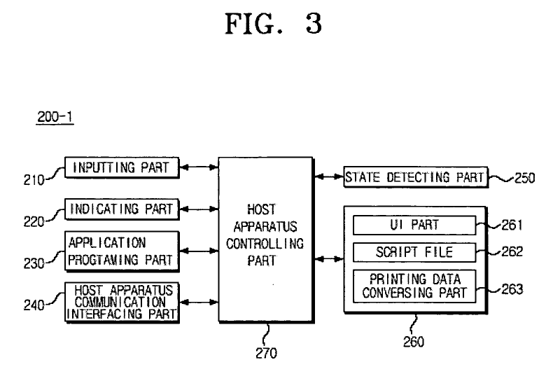

FIG. 2 is a detailed block diagram of the printing apparatus of FIG. 1, 2 and FIG. 3 is a detailed block diagram of a first host apparatus of FIG. 1. Hereinafter, referring to FIGS. 1 and 3, a first embodiment of the present invention will be described in detail. As shown in FIG. 2, the printing apparatus 100 comprises a tray 100, a recording medium size detecting part 120, a printing apparatus storing part 130, a printing apparatus communication interfacing part 140, a printing part 150, and a printing apparatus controlling part 160.

The tray 110 supplies recording media to the printing part 150. The recording medium size detecting part 120 detects the size of the recording medium in the tray 110 and supplies the detected size to the printing apparatus controlling part 160. The printing apparatus storing part 130 stores various programs and data necessary to perform functions of the printing apparatus 100. The printing apparatus storing part 130 also stores information on standardized sizes of recording media (e.g., A4, A5, B5, and LETTER) which are supported as default sizes by the printing apparatus 100. The printing apparatus communication interfacing part 140 is involved in data transmission and receipt between the printing apparatus 100 and the first through the n host apparatus 200-1, 200-2, . . . , 200-n. The printing apparatus communication interfacing part 140 transmits information on size of the recording medium detected at the recording medium size detecting part 120 to the first through the n host apparatus 200-1, 200-2, . . . , 200-n.

The printing part 150 prints printing data transmitted from the first through the n host apparatuses 200-1, 200-2, . . . , 200-n under the control of the printing apparatus controlling part 160. The printing apparatus controlling part 160 controls overall operations of the printing apparatus 100, and, in particular, transmits information on the size of the recording medium detected by the recording medium size detecting part 120 to the first through the n host apparatus 200-1, 200-2, . . . , 200-n, through the printing apparatus communication interfacing part 140. The printing apparatus controlling part 160 determines whether the detected size of the recording medium fits the standardized size of the recording medium that is pre-registered at the printing apparatus storing part 130. When the detected size of the recording medium in the tray is determined to be nonstandardized, the detected size of recording medium is transmitted to the first through the n host apparatuses 200-1, 200-2, . . . , 200-n.

Referring to FIG. 3, as shown in FIG. 3, the first host apparatus 200-1 comprises an inputting part 210, a displaying part 220, an application programming part 230, a host apparatus communication interfacing part 240, a state detecting part 250, a printer driver 260, and a host apparatus controlling part 270. The printer driver 260 comprises an UI part 261, a script file 262 and a printing data conversing part 263.

The displaying part 210 receives a user command to set or select various functions supported by the first host apparatus 200-1. The inputting part 210 may comprise a keyboard and a mouse. The displaying part 220 comprises various application programs to support a user interface and a printer driver user interface under the control of the host apparatus controlling part 270. According to an embodiment of the present invention, the displaying part 220 displays a printing option setting menu that is offered from the printer driver 260 from which a user selects a size of a recording medium for a printing of a document (i.e., from the recording medium selection item of the printing option setting menu). The printing part 220 may be a printer.

The application programming part 230 provides the application program to be used for the making of documents or images, and may be a word processor program such as Area Hangul, Excel, and/or Microsoft Word. The host apparatus communication interfacing part 240 connects the host apparatus 200 to external devices. Connected to the host apparatus communication interfacing part 240, the host apparatus serves as a channel across which data information on printing are received and transmitted.

The state detecting part 250 may be a utility program such as a status monitor receiving information on the state of the printing apparatus 100 (i.e., an on/off state, a paper jam state, and a lack of developing agent state) from the printing apparatus 100. In particular, the state detecting part 250 receives the information on the size of a recording medium transmitted from the printing apparatus 100 to the host apparatus controlling part 270.

The printer driver 260 converts the document completed by the application programming part 230 into the printing data, displays the printing option menu to allow for a setting of the printing option (for example, resolution, collection printing, reduction printing, printing range, and a size of the recording medium) to apply for the document at the displaying part 220, and allows the user to set the printing option. In particular, when receiving the command to select the recording medium from the user, the printer driver 260 indicates a list including the size of the recording medium transmitted form the printing apparatus 100.

More particularly, the printer driver 260 comprises a UI part 261, a script file 262, and a printing data conversing part 263. When the printing option setting is requested from the user, the UI part 261 displays the printing option setting menu on the displaying part 220 and allows the user to set the printing option. In particular, when receiving the command for selecting the recording medium from the user, the UI part 261 indicates a list of sizes of the recording media including the size of the recording medium transmitted from the printing apparatus 100, referring to the script file 262.

The script file 262 is referred when the list of sizes of the recording medium is displayed on the displaying part 220 by the UI part 261, and includes standardized sizes of papers such as A4, A3, B52, and LETTER, as a default. The nonstandardized recording medium defined by a user may also be included. In particular, the script file may also include a section devoted to the size of the recording medium transmitted from the printing apparatus 100 and registers.

The printing data conversing part 263 converts a document, which is requested to be printed by the application programming part 230, into the printing data interpretable by the printing apparatus 100. In particular, the printing data conversing part 263 converts the document into the printing data such that the printing data fits the size of the recording medium selected by the user.

The host apparatus controlling part 270 controls overall operations of the host apparatus 200, and, particularly, determines whether the size of the recording medium transmitted from the printing apparatus 100 is pre-registered to the printer driver 260. When the size is not pre-registered, the host apparatus controlling part registers the size of the recording medium transmitted to the printer driver 260. The size of the recording medium is then included in the section of the script file 261 that is devoted to the size of the recording medium transmitted from the printing apparatus 100 or the printer driver 260.

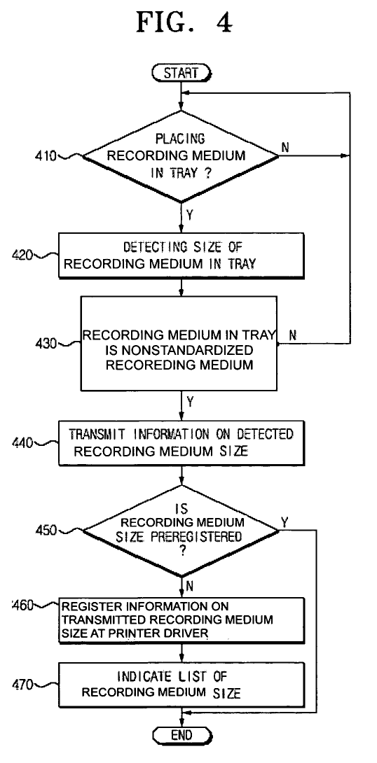

FIG. 4 is a flow chart of a printing control method of the printing system according to a first embodiment of the present invention. Referring to FIGS. 1 through 4, when recording media are filled in a tray 110, 410, a recording medium detecting part 120 detects a size of a recording medium in the tray and provides the detected size to a printing apparatus controlling part 160, S420.

The printing apparatus controlling part 160 compares the standardized size of recording medium having the detected size of the recording medium pre-registered with the printing apparatus storing part 130 and determines whether the size of the recording medium in the tray 110 is a nonstandardized size, 430. When the size determined to be nonstandardized, information on the detected size of the recording medium is transmitted to the first through the n host apparatuses 200-1, 200-2, . . . , 200-n, S440. The information on the detected size of the recording medium may also be broadcast to all the host apparatuses connected to network, and multicast or unicast to particular host apparatuses.

The state detecting part 260 receives information on the size of the recording medium transmitted from the printing apparatus and transmits the information to the host apparatus controlling part 270. The host apparatus controlling part 270 determines whether the transmitted size of the recording medium is pre-registered at the printer driver 260, 450, and when the transmitted size is determined to not be pre-registered, registers the size at the printer driver 260, 460. More particularly, the transmitted size of the recording medium is registered at the section of the script file 272 devoted to the size of the recording medium. Even when the size of the recording medium in the tray 100 is not pre-registered, the printer driver 270 installed at each of the first through the n host apparatuses 200-1, 200-2, . . . , 200-n displays a list of sizes of the recording medium including the detected size of the recording medium at the printing apparatus 100, 470, without requiring a user to perform manual setting, and allows the user select the size of the recording medium.

According to an embodiment of the present invention, whether the size of the recording medium in a tray is nonstandardized is determined, and, when found to be nonstandardized, the detected size of the recording medium is transmitted toward the host apparatus. However, operation 430 may be skipped and information on the detected size of the recording medium may be transmitted directly to the first through the n host apparatuses 200-1, 200-2, . . . , 200-n.

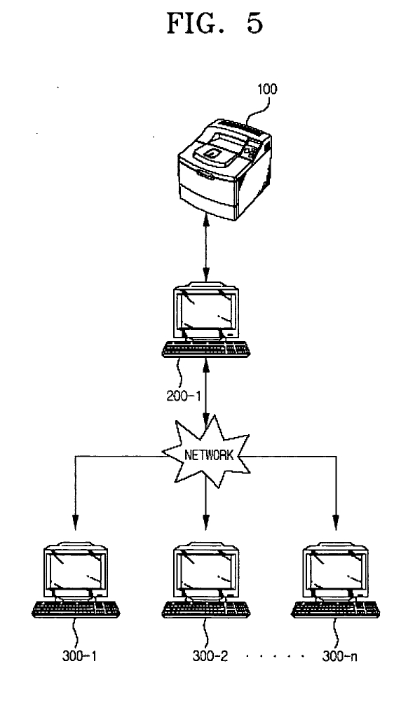

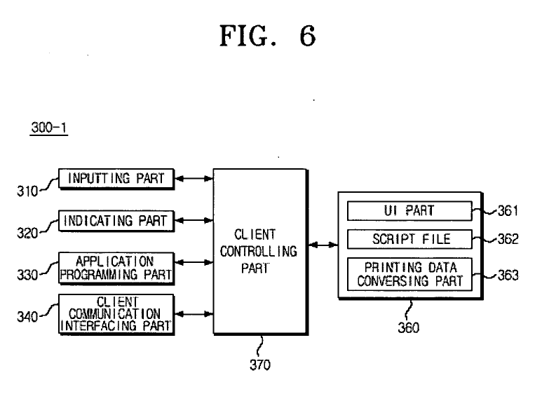

FIG. 5 is a block diagram of the printing system according to a second embodiment of the present invention. Referring to FIGS. 2 and 3, and FIGS. 5 and 6, a printing system according a second embodiment of the second present invention comprises a printing apparatus 100 and a first and a n client 300-1, 300-2, . . . , 300-n sharing the printing apparatus 100 through the first host apparatus 200-1 directly connected with the printing apparatus 100 and the first host apparatus 200-1 to the network.

The printing apparatus 100 and the first host apparatus 200-1 are directly connected through a series port, a parallel port or a USB port. The printing apparatus 100 and the first host apparatus 200-1 have the same structures as in the first embodiment of the present invention, and the same registration operations of registering the information on the size of the recording medium in the tray 110 of the printing apparatus 100 at the printer driver 260 of the first host apparatus 200-1.

The information on the size of the recording medium detected at the printing apparatus 100 is not broadcast to the first host apparatus 200-1 through the network, but transmitted and received through a printing apparatus communication interfacing part 140 and a host apparatus communication interfacing part 240 which are mutually connected through the series port, the parallel port and the USB port.

When the size of the recording medium transmitted from the printing apparatus 100 is not pre-registered at the printer driver 260 of the first host apparatus 200-1, the host apparatus controlling part 270 includes the transmitted size of the recording medium in the script file 262 of the printer driver 260, registers, and transmits the transmitted size to the first and the n client 300-1, 300-2, . . . , 300-n.

The first and the n client 300-1, 300-2, . . . , 300-n may be connected through the first host apparatus 200-1 and the network, and the printing apparatus 100, being directly connected to the first host apparatus 200-1, is shared with the first host apparatus 200-1. The inputting part 310, the displaying part 320, the application programming part 330, the client communication interfacing part 340, the printer driver 360 and the client controlling part 370 of the first client 300-1 operate in correspondence with the inputting part 210, the displaying part 220, the application programming part 230, the host apparatus communication interfacing part 240, the printer driver 260, and the host apparatus controlling part 270 of the first host apparatus 200-1.

According to an embodiment of the present invention, the client controlling part 370 includes the size of the recording medium included in the script file transmitted from the host apparatus 200-1 into the script file 362 pf the client 300-1 and registers. The printer driver 370 of the first and the n client 300-1, 300-2, . . . , 300-n, which is not directly connected to the printing apparatus 100, may not need manual setting for the use, even when the size of the recording medium in the tray is not pre-registered.

According to aspects of the present invention, whenever a recording medium, not registered at the printer driver, is used for printing, the size of the recording medium defined by a user needs automatic registration at the printer driver not a manual setting at the printer driver. Also, the size of the recording medium detected from the printing apparatus is transmitted collectively to all the host apparatuses connected to the network, and registered, so that removal requires an inconvenient process of manually setting a user-defined size of the recording medium for each host apparatus. The size of the recording medium in the tray is precisely detected through a size of the recording medium detecting part and registered, so that a possible error is minimized when a user-defined size of the recording medium is manually formed by the conventional user and the printing is properly performed.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A printing control method, comprising:
detecting a size of a recording medium in a tray of a printing apparatus;
transmitting the detected size of the recording medium to at least one host apparatus; and
registering the transmitted size of the recording medium at a printer driver of the host apparatus when the transmitted the size of the recording medium is not pre-registered at the printer driver.

2. The printing control method of claim 1, further comprising indicating a list of sizes of recording media including the registered size of the recording medium when a command is input to the host apparatus to select the recording medium.

3. The printing control method of claim 1, wherein the transmitting to the host apparatus comprises transmitting the detected size of the recording medium to at least one host apparatus, when the detected size of the recording medium is nonstandardized.

4. The printing control method of claim 1, wherein, when the printing apparatus is connected with the host apparatus through a network, the detected size of the recording medium is broadcast to the host apparatus.

5. The printing control method of claim 1, wherein the registering at the printer driver comprises registering the transmitted size of the recording medium into a script file of the printer driver.

6. A printing control method for use with a host apparatus directly connected to a printing apparatus and at least one client sharing the printing apparatus through the host apparatus, the method comprising:
detecting a size of the recording medium in a tray of the printing apparatus;
transmitting the detected size of the recording medium to the host apparatus; and
registering the transmitted size of the recording medium at a printer driver of the host apparatus when the transmitted size of the recording medium is not pre-registered at the printer driver.

7. The printing control method of claim 6, further comprising registering the size of the recording medium at a printer driver of the client.

8. The printing control method of claim 7, wherein the registering comprises transmitting the size of the recording medium into a script file of the printer driver of the host apparatus.

9. The printing control method of claim 7, wherein the registering the size of the recording medium at a printer driver of the client comprises:
transmitting the script file of the printer driver of the host apparatus including the size of the recording medium to the client, and
including the size of the recording medium included in the transmitted script file of the printer driver of the host apparatus, into the script file of the printer driver of the client.

10. A printing apparatus, comprising:
a tray to house a recording medium therein,
a detecting part to detect the size of the recording medium in the tray; and
a printing apparatus controlling part to transmit the detected size of the recording medium to at least one host apparatus and to register the size with a printer driver installed at the host apparatus.

11. The printing apparatus of claim 10, further comprising a storing part to store a predetermined standardized size of recording medium, wherein the printing apparatus controlling part compares the detected size of the recording medium with the standardized size of the recording medium, and if the detected size of the recording medium is nonstandardized, the printing apparatus controlling part transmits the detected size of the recording medium to the host apparatus.

12. The printing apparatus of claim 10, wherein the printing apparatus controlling part, when connected with the host apparatus through network, broadcasts the detected size of the recording medium to the host apparatus.

13. A host apparatus, including a printer driver creating printing data interpretable at a printing apparatus, the host apparatus comprising:
a state detecting part to detect a size of a recording medium in a tray of the printing apparatus; and
a host apparatus controlling part to register the detected size of the recording medium with a printer driver when the detected size of the recording medium is not pre-registered with the printer driver.

14. The host driver of claim 13, wherein the printer driver displays a list of sizes of recording media when a command to select the recording medium is received.

15. The host driver of claim 13, wherein the printer driver includes a script file where the detected size of the recording medium is registered.

16. A printing control method for use with a printing apparatus having a tray to supply a recording medium to the printing apparatus connected to a network to which at least one host apparatus, having a printer driver installed therein, is connected thereto, comprising:
detecting a size of the recording medium;
transmitting the detected size of the recording medium to the at least one host apparatus; and
registering the transmitted size of the recording medium at a printer driver of the host apparatus when the transmitted the size of the recording medium is not pre-registered at the printer driver.

17. The printing control method of claim 16, further comprising indicating a list of sizes of recording media including the registered size of the recording medium when a command is inputted to the host apparatus to select the recording medium.

18. The printing control method of claim 16, wherein the transmitting to the at least one host apparatus comprises transmitting the detected size of the recording medium to the at least one host apparatus, when the detected size of the recording medium is nonstandardized.

19. The printing control method of claim 16, wherein the registering at the printer driver comprises registering the transmitted size of the recording medium into a script file of the printer driver.
